(19) United States
(12) Patent Application Publication
(10) Pub. No.: US 2012/0292434 A1
(43) Pub. Date: Nov. 22, 2012

(54) Six Degrees Of Freedom Vibration Suppression

(75) Inventor: William A. Welsh, North Haven, CT (US)

(73) Assignee: SIKORSKY AIRCRAFT CORPORATION, Stratford, CT (US)

(21) Appl. No.: 13/459,821

(22) Filed: Apr. 30, 2012

Related U.S. Application Data
(60) Provisional application No. 61/518,109, filed on Apr. 29, 2011.

(51) Int. Cl. F16F 15/18; B64C 27/82

(52) U.S. Cl. 244/17.27; 244/17.21

(57) ABSTRACT

A vibration suppression system for a rotorcraft having an airframe, a main gear box, a rotor, a hub, and a rotor head, said system comprising a hub mounted vibration suppressor (HMVS) mounted on the rotor head to reduce in-plane loads that the rotor exerts on the hub; and a plurality of active vibration control (AVC) actuators grouped in an overhead of the airframe beneath and proximate to the main gear box, to reduce residual loads.

### CROSS REFERENCE TO RELATED APPLICATIONS

This application claims the benefit of U.S. provisional patent application Ser. No. 61/518,109, filed Apr. 29, 2011, the entire contents of which are incorporated herein by reference.

### BACKGROUND

Vibration systems for current production rotorcraft (e.g., helicopters) do not nullify vibration close to the source, i.e., at the main rotor. Typical active vibration control (AVC) actuators are not placed close the main gear box (MGB), which is the pathway for virtually all of the rotor-induced vibration to enter a helicopter's fuselage.

Placing actuators near a virtually rigid body pathway of the vibration to nullify all vibratory motions of a rigid body is discussed in U.S. Pat. No. 6,105,900, which is incorporated herein by reference. However, placing actuators near the MGB mounting in the fuselage, i.e., all actuators remote from the main rotor hub, is not practical because the vibratory loads coming from the main rotor are too large, especially for a helicopter with 5 blades or less. These loads, if unsuppressed near the source, create large vibratory moments and thus any actuators used would need to be excessively large, would generate vibratory loads that are too large and require heavy airframe reinforcement. Consequently, there is a need to find a way to mount effective noise suppression actuators near the MGB.

### SUMMARY

An embodiment is a vibration suppression system for a rotorcraft having an airframe, a main gear box, a rotor, a hub, and a rotor head, said system comprising a hub mounted vibration suppressor (HMVS) mounted on the rotor head to reduce in-plane loads that the rotor exerts on the hub; and a plurality of active vibration control (AVC) actuators grouped in an overhead of the airframe beneath and proximate to the main gear box, to reduce residual loads.

### BRIEF DESCRIPTION OF THE DRAWINGS

FIG. 1 shows an HMVS plus overhead AVC units used to suppress motions of the main gearbox and nullify vibrations throughout the fuselage;

FIG. 2 shows computer simulations indicating that vibrations are virtually eliminated; and

FIG. 3 shows a vibration suppression system in an exemplary embodiment.

### DETAILED DESCRIPTION

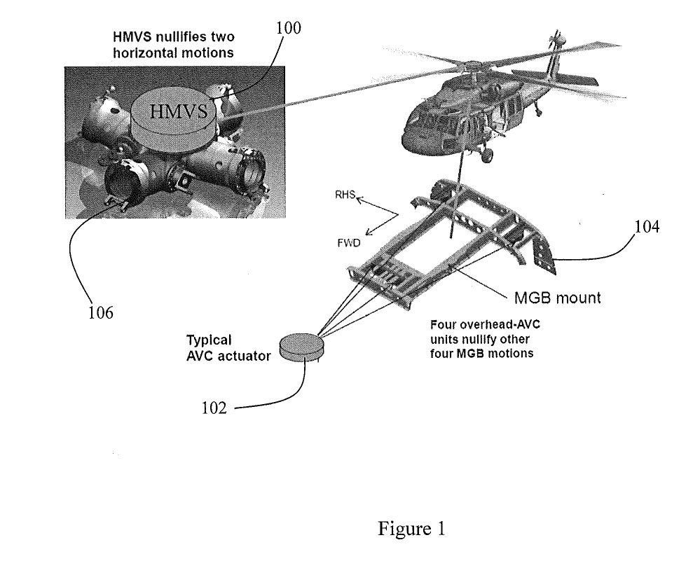

As shown in FIG. 1, embodiments combine a hub mounted vibration suppressor (HMVS) 100 with active vibration control (AVC) actuators 102. The AVC actuators 102 are placed in the fuselage near the main gear box (MGB) on a MGB mount 104. Four AVC actuators 102 are positioned near the MGB on the MGB mount 104 in an overhead of the aircraft. The result is that all six degrees of freedom of the MGB vibration are reduced or virtually nullified.

Embodiments use the HMVS 100 on the rotor head 106 to reduce or nullify the largest loads, i.e., the in-plane loads that the rotor exerts on the hub. A plurality, e.g., four more, much smaller, active vibration control (AVC) actuators 102 are grouped in the overhead of the airframe on the MGB mount 104 positioned under, but near the MGB, to reduce or nullify the other smaller, residual 4 loads.

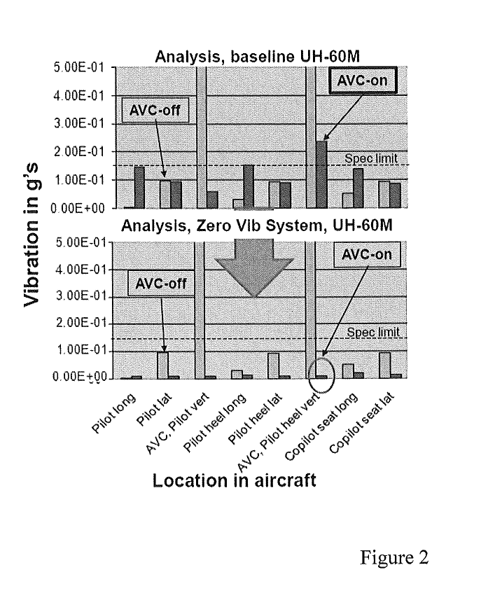

Simulation results, as shown in FIG. 2, indicate that virtually zero vibration is achievable using the combination of HMVS and AVC actuators positioned as discussed above.

The use of four AVC actuators 102 was unexpected, because it was previously thought that the non-planar torsional load from the main rotor could be ignored thus allowing only three AVC actuators 102 in the fuselage overhead. But it was unexpectedly discovered that the torsional load exerted by the main rotor on the main rotor hub and shaft is not attenuated by any “softness” in the drive system. Consequently, four AVC actuators 102 are used in the airframe to enable suppression of all of the loads being transmitted through the main gear box and into the fuselage.

In one embodiment, six actuators are used by the present invention. Four AVC actuators 102 are mounted on the fuselage, and two actuators are embodied in a dual HMVS 100. U.S. Pat. No. 7,448,854 provides an exemplary description of a dual HMVS system, and is incorporated herein by reference. One aspect of embodiments is that the all six actuators are controlled using feedback from sensors (typically accelerometers) which are mounted in the fuselage. All six actuators may be controlled, in concert, using feedback sensors in the fuselage.

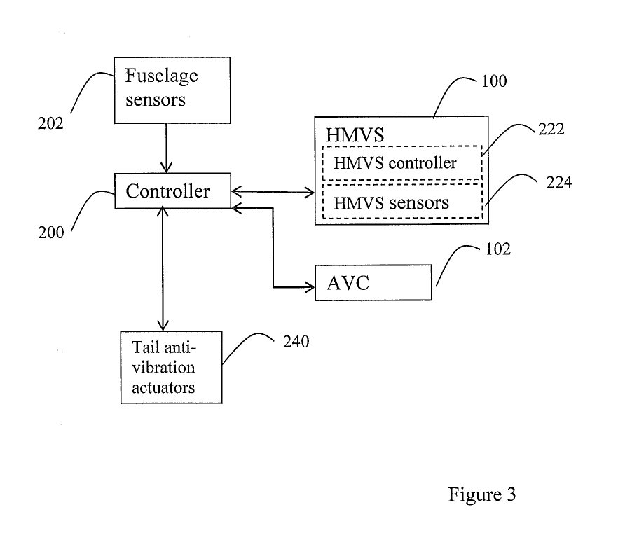

Previously it was believed that HMVS 100 should utilize sensors which are mounted internal to the HMVS 100 acting as an independent sensor-actuator combination to control in-plane motions of the hub while the actuators in the fuselage would independently utilize only sensors in the fuselage. However, unexpectedly, this type of “split” system does not work nearly as well as controlling all six actuators in a unified manner with a controller taking in sensor signals from the fuselage (typically about 10 fuselage sensors) and sending unified commands to all 6 actuators. FIG. 3 provides a vibration suppression system diagram illustrating a controller 200, fuselage sensors 202, HMVS 100 and AVC actuators 102. This configuration allows the controller 200 to control actuators in the HMVS 100 and the AVC 102 in a unified manner in response to fuselage sensors 202.

In one embodiment, a split system is used as a backup system in the event of a communications fault on the digital bus that connects the HMVS 100 to the fuselage based controller 200. In this fault case, the HMVS 100 would use its own HMVS controller 222 and HMVS sensors 224 built into the HMVS 100 and rotating with the rotor to act independently of the fuselage based portion of the system. Performance may be degraded in this mode, but it is acceptable for fly-home capability.

The total system weight is low because the HMVS 100 counteracts the in-plane loads from the main rotor at the main rotor hub. This leaves four smaller, residual loads that can be reduced or nullified with relatively small actuators mounted in the fuselage, these actuators mounted within a few feet of the MGB mounting locations, e.g., in the overhead. This results in lower weight and reduced or virtually zero vibration in the fuselage. This allows longer missions with reduced crew fatigue and lower cost of operation through reduced maintenance cost as parts break less frequently when not subjected to vibrations.

In one embodiment, an optional set of tail anti-vibration actuators 240 may be placed at or near the rear vertical and horizontal stabilizers to further reduce vibration arising from occasional rotor aerodynamic impingement on these tail planes. The tail anti-vibration actuators 240 would work hardest in descent or approach to hover. The tail anti-vibration actuators 240 are placed near the vibration source to avoid leakage of these loads into the entire airframe

The foregoing description is exemplary rather than defined by the limitations within. Many modifications and variations of the embodiments are possible in light of the above teachings. Exemplary embodiments have been disclosed, however, one of ordinary skill in the art would recognize that certain modifications would come within the scope of this invention. It is, therefore, to be understood that within the scope of the appended claims, embodiments may be practiced otherwise than as specifically described. For that reason the following claims determine the true scope and content of this invention.

1. A vibration suppression system for a rotorcraft having an airframe, a main gear box, a rotor, a hub, and a rotor head, said system comprising:
a hub mounted vibration suppressor (HMVS) mounted on the rotor head to reduce in-plane loads that the rotor exerts on the hub; and
a plurality of active vibration control (AVC) actuators grouped in an overhead of the airframe beneath and proximate to the main gear box, to reduce residual loads.

2. The vibration suppression system of claim 1, wherein there are at least four AVC actuators provided on the airframe to enable suppression of the residual loads.

3. The vibration suppression system of claim 1, wherein the HMVS includes a plurality of hub actuators.

4. The vibration suppression system of claim 3, further comprising:
a plurality of sensors for providing feedback to the plurality of hub actuators and the plurality of AVC actuators.

5. The vibration suppression system of claim 4, wherein the plurality of sensors are mounted in a fuselage of the airframe.

6. The vibration suppression system of claim 5, wherein the plurality of sensors are accelerometers.

7. The vibration suppression system of claim 4, wherein the HMVS includes HMVS sensors operational independent of the sensors.

8. The vibration suppression system of claim 1, further comprising:
tail anti-vibration actuators positioned proximate rear vertical and horizontal stabilizers of the rotorcraft at a rear section of a fuselage to reduce vibration arising from rotor aerodynamic impingement on the rear vertical and horizontal stabilizers of the rotorcraft.

9. The vibration suppression system of claim 1, further comprising:
a controller providing coordinated control information to both the HMVS and the AVC actuators to reduce vibration.

10. The vibration suppression system of claim 9, wherein the HMVS includes an HMVS controller operational independent of the controller.

11. A vibration suppression system on a rotorcraft having a rotor head, and a fuselage, said system comprising:
a hub mounted vibration suppressor (HMVS) system mounted on the rotor head, said HMVS system including a plurality of HMVS actuators;
an active vibration control (AVC) system, distributed in the fuselage, said AVC system having a plurality of AVC actuators; and
a controller providing coordinated control information to the HMVS actuators and the AVC actuators to reduce vibration.
